(19) United States
(12) Patent Application Publication
(10) Pub. No.: US 2013/0074279 A1
(43) Pub. Date: Mar. 28, 2013

(54) System for an Extendable Handheld Trowel

(71) Applicant: Scott James BRIDGES, Odessa, FL (US)

(72) Inventor: Scott James BRIDGES, Odessa, FL (US)

(21) Appl. No.: 13/623,766

(22) Filed: Sep. 20, 2012

Related U.S. Application Data
(60) Provisional application No. 61/537,883, filed on Sep. 22, 2011.

(51) Int. Cl. E04F 21/08; B05C 17/00; B25G 1/04; E01C 19/18

(52) U.S. Cl. 15/144.4

(57) ABSTRACT

The system for an extendable handheld trowel is a tool with interchangeable blades and an extendable handle. The system comprises a plurality of trowels, a first shaft, a second shaft, and a telescopic lock mechanism. Each trowel comprises a trowel blade and an extension arm. The extension arm properly connects and positions the trowel blade to the first shaft. The extension arm attaches and detaches from the first shaft so that a user can switch to a different kind of trowel. The first shaft is sleeved by the second shaft, which allows the user to extend the reach of a trowel. The second shaft comprises a receiving end and a handle. The telescopic lock mechanism secures the first shaft to the second shaft so that the distance between the trowel blade and the handle is at a specific length. The handle allows the user to adequately grasp the second shaft.

The current application claims a priority to the U.S. Provisional Patent application Ser. No. 61/537,883 filed on Sep. 22, 2011.

### FIELD OF THE INVENTION

The present invention relates generally to a system of interchangeable trowels. More specifically, each of the interchangeable trowels can be attached to an extendable handle.

### BACKGROUND OF THE INVENTION

A trowel is used for spreading a substance. When reaching in a typical 5-gallon bucket that contains the substance, a normal hand held trowel is too short to reach the bottom of the bucket without getting some of this usually messy substance on a user's gloves, arms or hands. It is therefore an object of the present invention to provide a trowel with an adjustable handle that reduces mess on the user's gloves or arms and hands from reaching into the 5-gallon buckets of roof cement, roof coating, modified roof cement, plaster, concrete, or glue as the trowel reaches the bottom of any 5-gallon bucket without the user having to enter his or her hands or arms into the bucket. It is a further object of the present invention to provide a trowel that can work in hard to reach places such as under roof overhangs for spreading tar.

### BRIEF DESCRIPTION OF THE DRAWINGS

FIG. 1 is a front exploded view of the system of the present invention.

FIG. 2 is a back exploded view of the system of the present invention.

FIG. 3 is a front perspective view of the present invention in a contracted form.

FIG. 4 is a front perspective view of the present invention in an extended form.

FIG. 5 is a schematic view of the present invention in the extended form, which is illustrating a first embodiment of the telescopic lock mechanism in the unlocked position.

FIG. 6 is a schematic view of the present invention in the extended form, which is illustrating the first embodiment of the telescopic lock mechanism in the locked position.

FIG. 7 is a schematic view of the present invention in the contracted form, which is illustrating a first embodiment of the telescopic lock mechanism in the unlocked position.

FIG. 8 is a schematic view of the present invention in the contracted form, which is illustrating the first embodiment of the telescopic lock mechanism in the locked position.

FIG. 9 is a back perspective view of the present invention, which is illustrating a second embodiment of the telescopic lock mechanism in the locked position.

FIG. 10 is a back perspective view of the present invention, which is illustrating the second embodiment of the telescopic lock mechanism in the unlocked position.

### DETAILED DESCRIPTIONS OF THE INVENTION

All illustrations of the drawings are for the purpose of describing selected versions of the present invention and are not intended to limit the scope of the present invention.

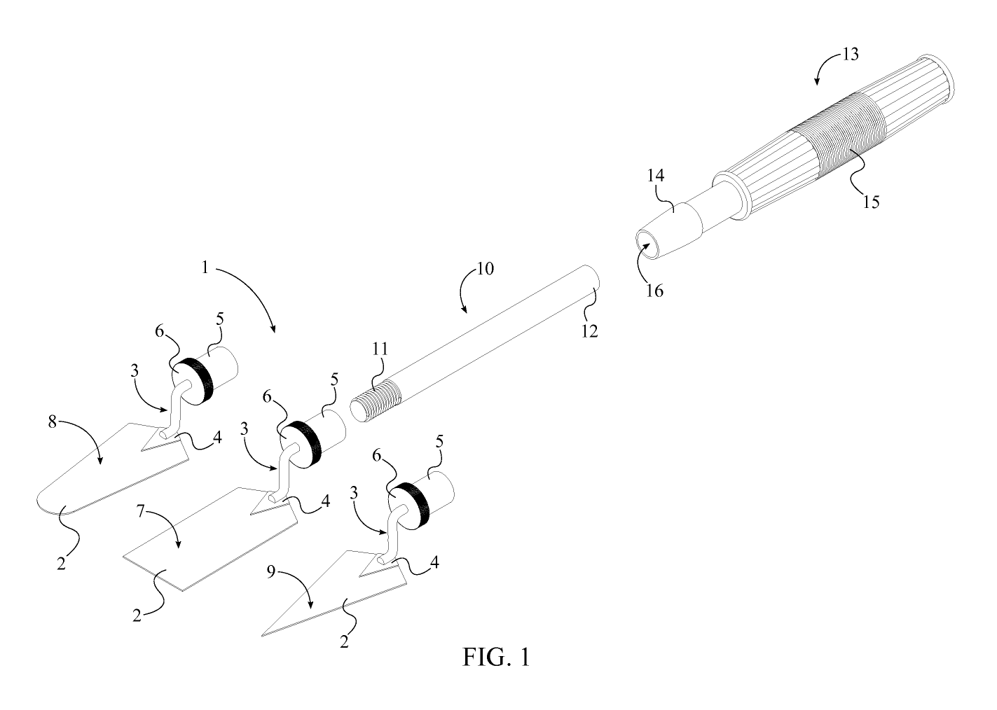

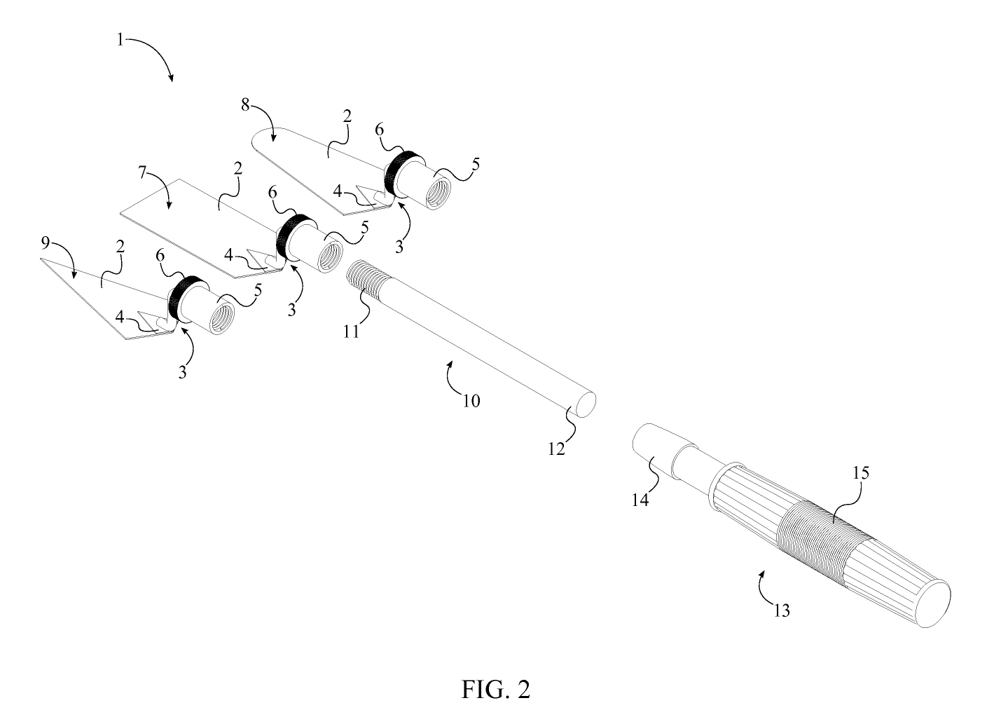

As can be seen in FIGS. 1 and 2, the present invention is a system for an extendable handheld trowel, which allows multiple trowels to be attached to a telescopic handle. The system for an extendable handheld trowel can be used in a variety of applications but is primarily used in roofing, cement, and stucco applications. In the preferred embodiment, the present invention uses a masonry or margin trowel, which is used to spread or apply mortar or concrete. The present invention comprises a plurality of trowels 1, a first shaft 10, a second shaft 13, and a telescopic lock mechanism 17. The first shaft 10 is sleeved by the second shaft 13, which allows the first shaft 10 and the second shaft 13 to telescope one another. The telescopic motion between the first shaft 10 and the second shaft 13 allows the present invention to extend the reach for the plurality of trowels 1. Each of the plurality of trowels 1 can be interchangeably attached to the first shaft 10 so that a user can choose a specific kind of trowel for a certain application. The plurality of trowels 1 includes, but is not limited to, a square margin trowel 7, a large round trowel 8, and a pointed margin trowel 9. Finally, the telescopic lock mechanism 17 allows the user to secure the first shaft 10 and the second shaft 13 at a specific length.

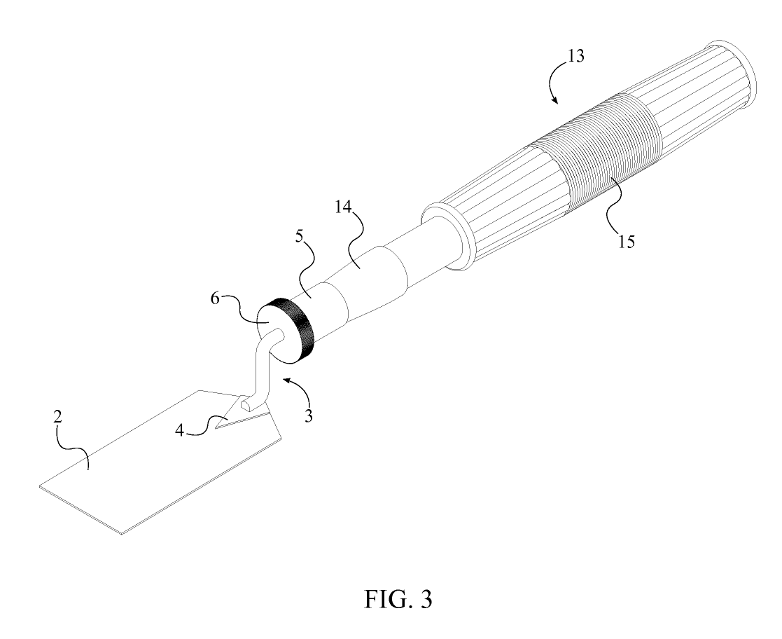

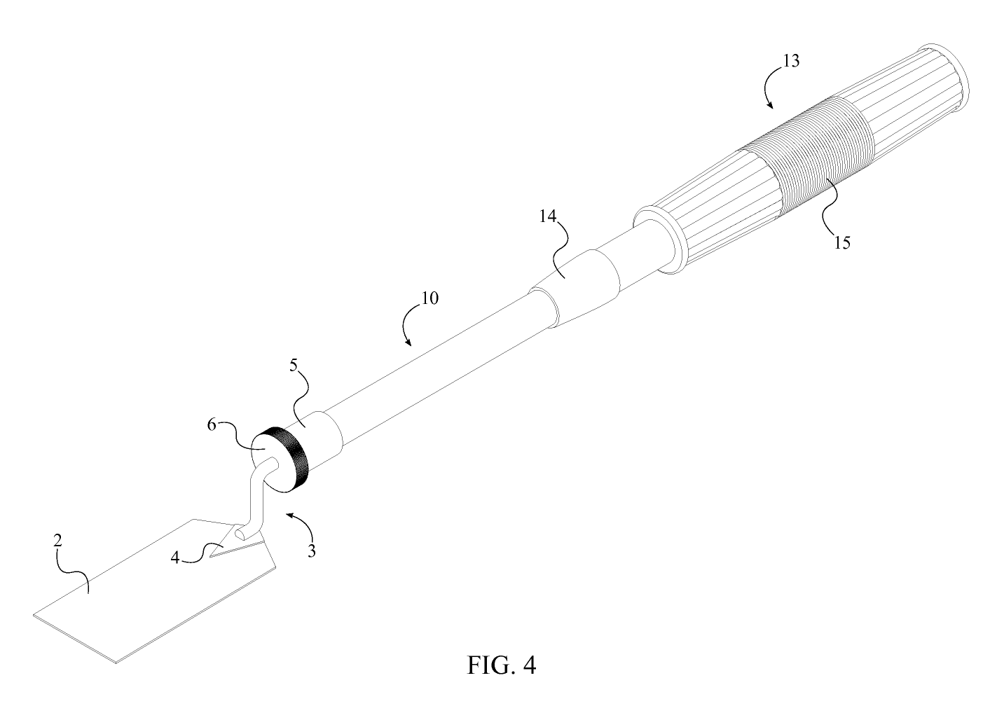

Each of the plurality of trowels 1 has common components that are used in conjunction with the first shaft 10 and the second shaft 13. Each of the plurality of trowels 1 comprises a trowel blade 2 and an extension arm 3, which are shown in FIGS. 3 and 4. The trowel blade 2 is used to accomplish the primary utility of the present invention, which is to spread or apply mortar or to do any other trowel-related applications. The shape and size of the trowel blade 2 can vary between the square margin trowel 7, the large round trowel 8, the pointed margin trowel 9, and any other kind of trowel. The extension arm 3 attaches the trowel blade 2 to the first shaft 10. The extension arm 3 is also used to properly position the trowel blade 2 with the first shaft 10 so that the present invention is easier to use. The extension arm 3 comprises a blade bracing portion 4, a threaded port 5, and an annular grip 6. The blade bracing portion 4 and the threaded port 5 are positioned opposite to each other along the extension arm 3. The annular grip 6 encircles and is connected to the threaded port 5. The trowel blade 2 is adjacently connected to the blade bracing portion 4, which adequately secures the trowel blade 2 to the extension arm 3. In addition, the blade bracing portion 4 is used to position the trowel blade 2 parallel to the threaded port 5 so that the first shaft 10 is also positioned parallel to the trowel blade 2. The parallel relation between the trowel blade 2 and the first shaft 10 provides the present invention with an ergonomic configuration. The threaded port 5 is the female portion of the attachment between the extension arm 3 and the first shaft 10. In the preferred embodiment of the present invention, both the trowel blade 2 and the extension arm 3 are made of a metal material.

As can be seen in FIGS. 3 and 4, the telescopic motion of the first shaft 10 and the second shaft 13 allows the present invention to extend the reach of the trowel blade 2. The first shaft 10 is a structural component for the present invention because the second shaft 13 sleeves the first shaft 10 and because the first shaft 10 is used to attach each of the plurality of trowels 1 to the rest of the present invention. The first shaft 10 comprises a threaded end 11 and an insertion end 12. The threaded end 11 and the insertion end 12 are positioned opposite to each other along the first shaft 10. The threaded end 11 is the male portion of the attachment between the extension arm 3 and the first shaft 10. The annular grip 6 for each of the plurality of trowels 1 allows the user to adequately grasp a trowel while rotating the threading end of the first shaft 10 into the threaded port 5. Thus, the threaded port 5 is engaged by the threaded end 11 in order to attach the extension arm 3 to the first shaft 10. In alternate embodiments of the present invention, the attachment between the extension arm 3 and the first shaft 10 can be accomplished with a variety of mechanisms, but these mechanisms must always be capable of engaging and disengaging the first shaft 10 from the extension arm 3 so that each of the plurality of trowels 1 can be interchangeably connected to the first shaft 10. The insertion end 12 is the portion of the first shaft 10 that is located within the second shaft 13. In the preferred embodiment of the present invention, the first shaft 10 is a total of 7 inches long, and the threaded end 11 is 1 inch long. Also in the preferred embodiment, the threaded end 11 has an Acme thread form, which includes thread profiles of a trapezoidal design. In addition, the first shaft 10 can be constructed from, but not limited to, metal or aluminum.

The second shaft 13 is used as the means to extend the reach of the present invention. The second shaft 13 comprises a receiving end 14, a handle 15, and a shaft hole 16. The handle 15 allows the user to adequately grasp the second shaft 13 while working with the present invention, and the receiving end 14 allows the first shaft 10 to be inserted into the second shaft 13. The receiving end 14 and the handle 15 are positioned opposite of the each other along the second shaft 13. The shaft hole 16 guides the sliding movement of the first shaft 10 into and out of the second shaft 13. The shaft hole 16 is concentrically positioned through the receiving end 14 and into the handle 15. Consequently, the insertion end 12 of the first shaft 10 can traverse into the shaft hole 16. In the preferred embodiment of the present invention, the handle 15 can be constructed from, but not limited to, rubber or plastic, and the handle 15 has a series of ridges and grooves, which aid the user to grasp the handle 15 while operating the present invention.

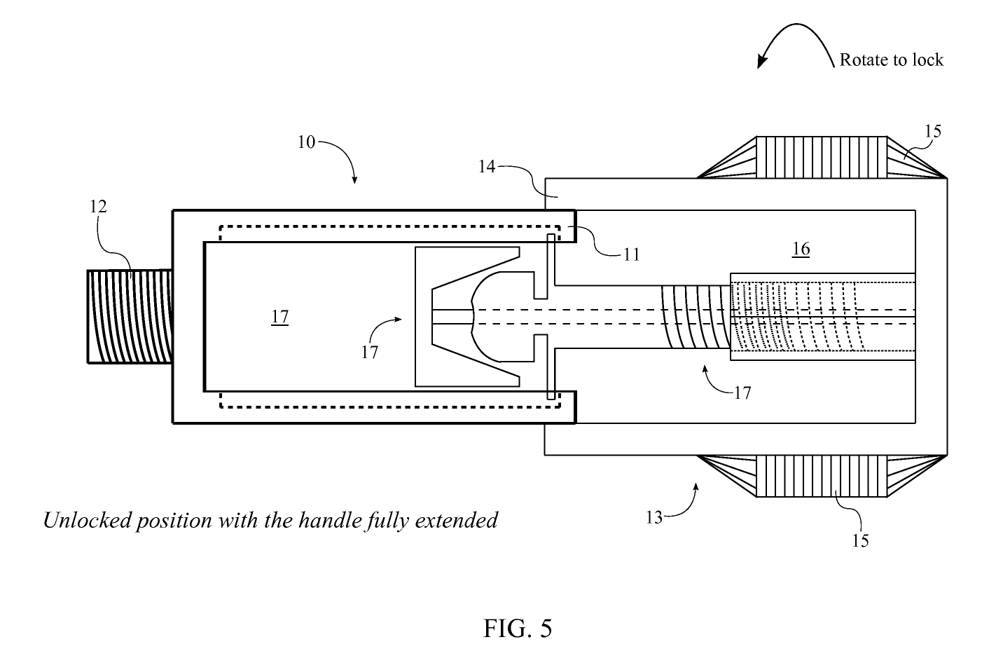

The telescopic lock mechanism 17 allows the second shaft 13 to lock onto a specific portion of the first shaft 10 so that the user extends the reach of the present invention to a desired length. In the preferred embodiment, the telescopic lock mechanism 17 is an internal mechanism that cannot be seen by the user from the outside, that can be engaged or disengaged by rotating the first shaft 10 and the second shaft 13 in opposite directions, and that allows the second shaft 13 to be locked to any place along the first shaft 10. In the preferred embodiment, the telescopic lock mechanism 17 could comprise a first tubular cavity, a cam, a plastic expander, an expander rod, an expander hole, a pair of tracks, a circular plate, a threaded rod, and a threaded tube, which can be seen in FIG. 5-8. The first tubular cavity traverses into the first shaft 10, and the first tubular cavity and the shaft hole 16 encapsulate the telescopic lock mechanism 17. The plastic expander is sized to concentrically fit within the first tubular cavity and is connected to the second shaft 13 at the back of the shaft hole 16 by the expander rod. The expander rod keeps the plastic expander at a constant length from the back of the shaft hole 16. The threaded tube encircles the expander rod and is connected to the second shaft 13 at the back of the shaft hole 16. One end of the threaded rod is engaged to the threaded tube so that the combined length of the threaded rod and the threaded tube is able to expand and contract. The circular plate is concentrically connected to the other end of the threaded rod and is concentrically positioned within the first tubular cavity. The circular plate comprises a pair of the guides, wherein the pair of guides protrudes from the circular plate opposite to each other. Each of the pair of guides traverses into the pair of tracks, wherein the pair of guides is positioned opposite to each other along the first shaft 10 within the first tubular cavity. The pair of tracks and the pair of guides prevent the threaded rod from rotating while the threaded tube is being rotated, which allows the user to expand or contract the combined length of the threaded tube and the threaded rod by rotating the threaded tube. The cam is concentrically connected to the circular plate opposite to the threaded rod. The cam, the circular plate, the threaded rod, and the threaded tube are positioned in between the plastic expanded and the back of the second tubular cavity, and, thus, the expander rod needs to traverse through the expander hole, which is concentrically positioned through the cam, the circular plate, and the threaded rod.

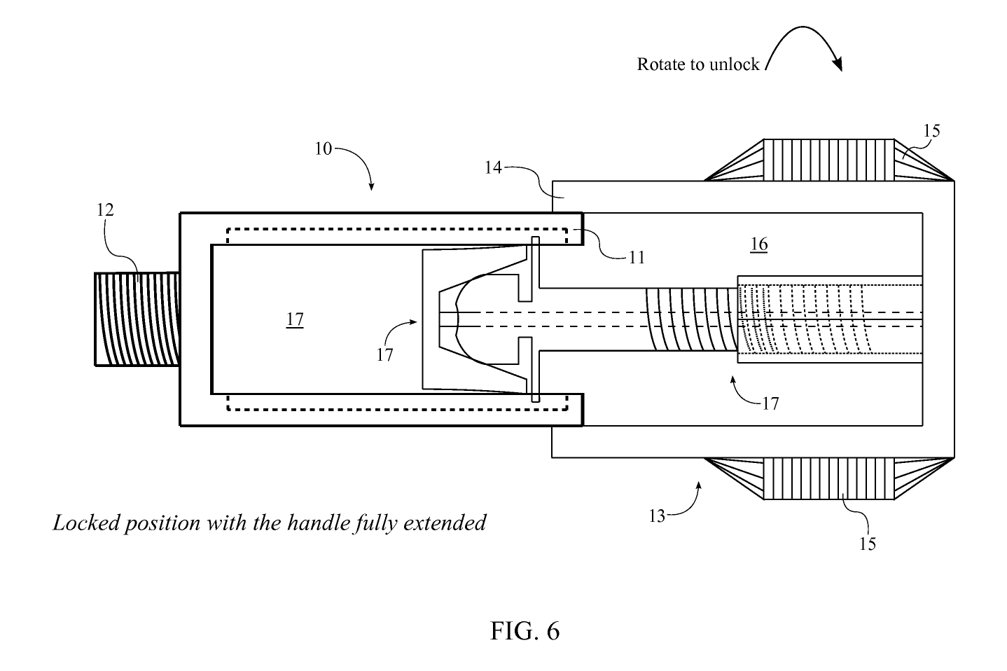

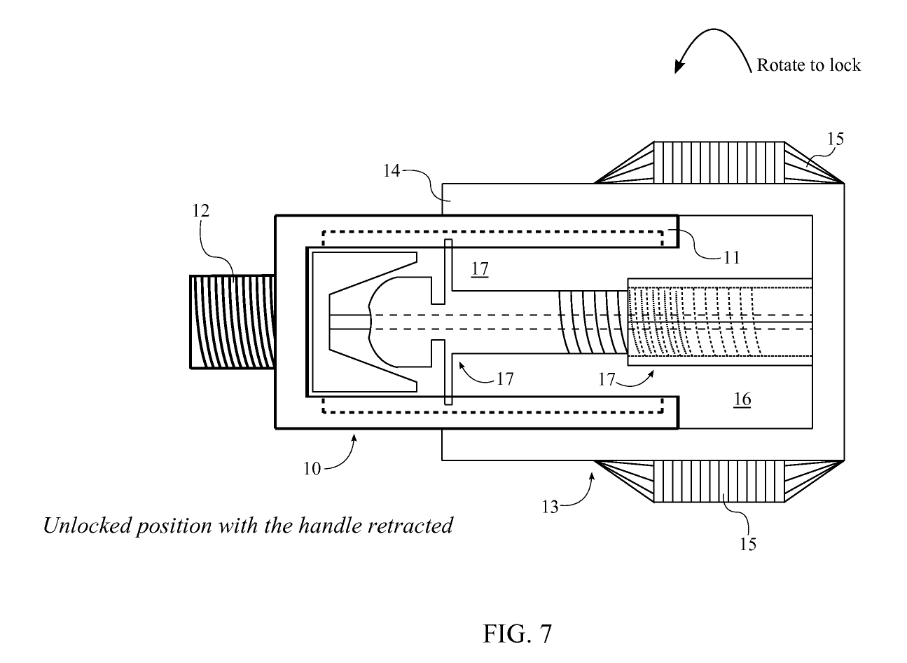

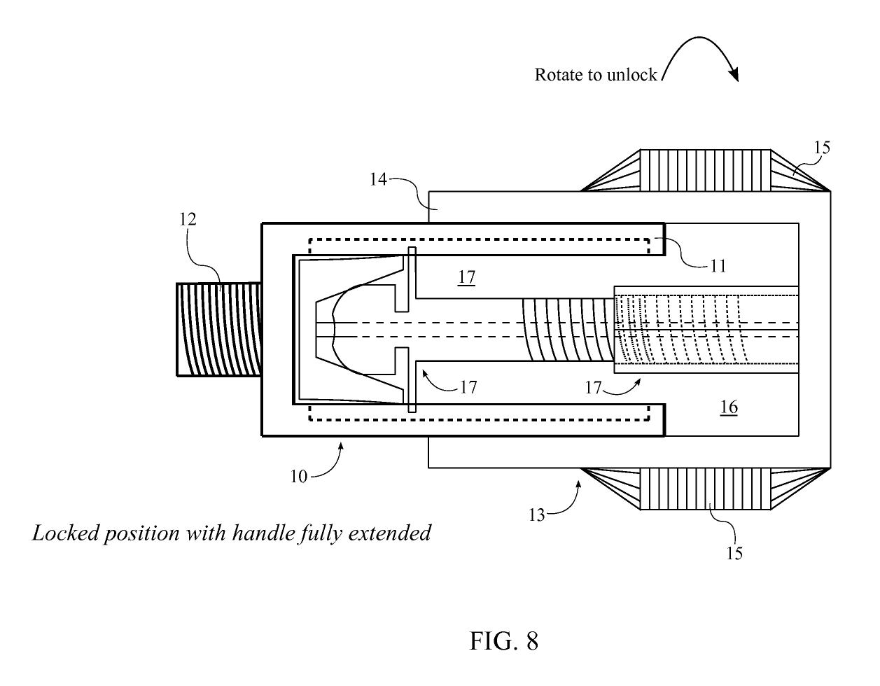

This embodiment of the telescopic lock mechanism 17 uses a twist-lock motion in order to change between a locked position and an unlocked position. In order to move the telescopic lock mechanism 17 to the locked position, the user grasps the handle 15 and rotates the second shaft 13 in one direction, which rotates the threaded tube in the same direction as can be seen in FIGS. 6 and 8. The engagement between the threaded tube and the threaded rod changes the rotational motion from the second shaft 13 into linear motion by the threaded tube and the threaded rod. For the locked position, the linear motion increases the combined length of the threaded tube and the threaded rod, which presses the cam into the plastic expander and pushes the lateral surface of the plastic expander against the inner wall of the first shaft 10. Consequently, the friction between the lateral surface of the plastic expander and the inner wall of the first shaft 10 locks the second shaft 13 to the first shaft 10. In order to move the telescopic lock mechanism 17 to the unlocked position, the user grasps the handle 15 and rotates the second shaft 13 in the opposite direction, which rotates the threaded tube in the opposite direction as can be seen in FIGS. 5 and 7. Similarly, the engagement between the threaded tube and the threaded rod changes the opposite rotational motion from the second shaft 13 into linear motion by the threaded tube and the threaded rod. For the unlocked position, the linear motion decreases the combined length of the threaded tube and the threaded rod, which retracts the cam from the plastic expander and stops lateral surface of the plastic expander from pressing against the inner wall of the first tube. Consequently, the first shaft 10 is able to freely telescope the second shaft 13 because the first shaft 10 is not experiencing friction from the plastic expander.

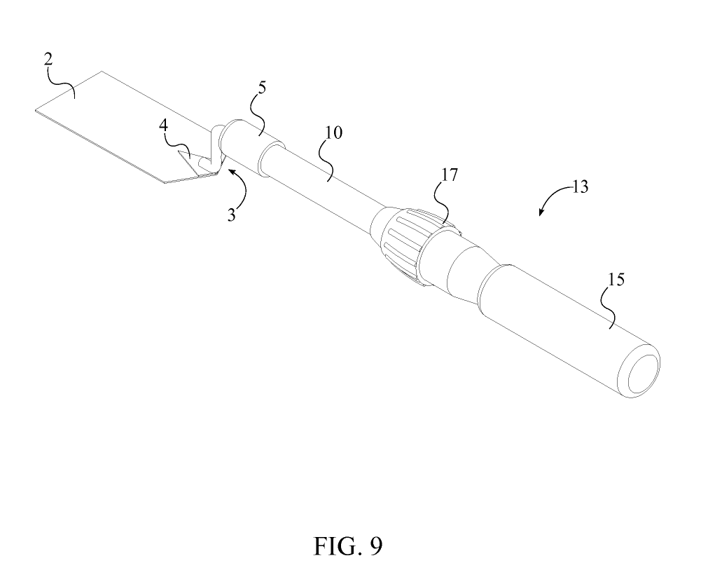

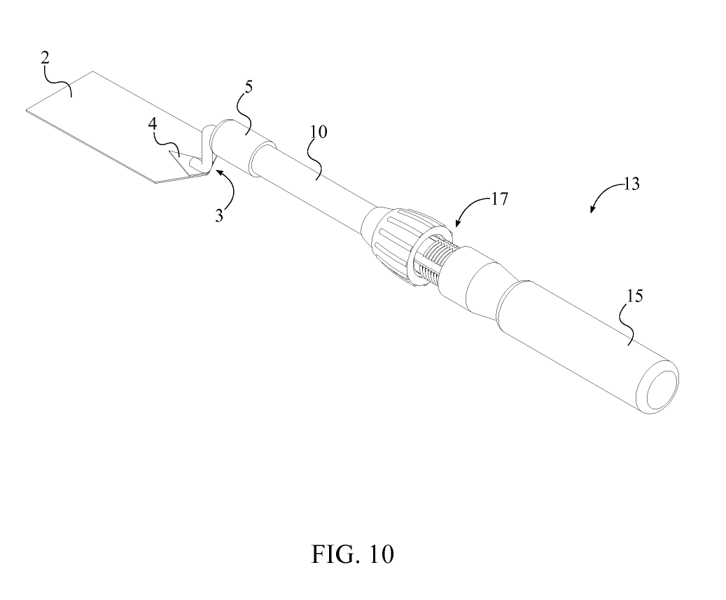

In another embodiment of the present invention, the telescopic lock mechanism 17 can be an annular device connected to receiving end 14 opposite to the handle 15, which is shown in FIGS. 9 and 10. This embodiment of the telescopic lock mechanism 17 comprises a lock threaded port 5 and a lock threaded insert, wherein the lock threaded insert additionally comprises a plurality of grips. When the lock threaded port 5 is disengaged from the lock threaded insert, the plurality of grips does not press against the lateral surface of the first shaft 10, which allows the first shaft 10 to slide within the second shaft 13 as can be seen in FIG. 10. Once the lock threaded port is engaged by the lock threaded insert, the plurality of grips will then press against the lateral surface of the first shaft 10 in order to prevent the first shaft 10 from sliding within the second shaft 13 as can be seen in FIG. 9. More specifically in this embodiment of the present invention, the telescopic lock mechanism 17 is 3 inches long and the handle 15 is 4 inches long. The telescopic lock mechanism 17 in this embodiment can also be constructed from, but is not limited to, plastic. Additionally for this embodiment, both the telescopic lock mechanism 17 and the handle 15 can each have a series of ridges and grooves, which aid the user to grasp the telescopic lock mechanism 17 and the handle 15 while operating the present invention.

Although the invention has been explained in relation to its preferred embodiment, it is to be understood that many other possible modifications and variations can be made without departing from the spirit and scope of the invention as hereinafter claimed.

What is claimed is:

1. A system for an advanced reaching trowel comprises,
a plurality of trowels;
a first shaft;
a second shaft;
each of said plurality of trowels comprises a trowel blade and an extension arm;
said first shaft comprises a threaded end and an insertion end;
said second shaft comprises an outer telescopic lock, a handle, and a shaft hole;
said extension arm comprises a blade bracing portion and a threaded port; and
said first shaft being sleeved by the second shaft.

2. The system for an advanced reaching trowel as claimed in claim 1 comprises,
said blade bracing portion and said threaded port being positioned opposite to each other along said extension arm;
said trowel blade being connected adjacent to said blade bracing portion; and
said trowel blade and said threaded port being positioned parallel to each other.

3. The system for an advanced reaching trowel as claimed in claim 1 comprises,
said threaded end and said insertion end being positioned opposite to each other along said first shaft; and
said threaded port being engaged by said threaded end.

4. The system for an advanced reaching trowel as claimed in claim 1 comprises,
said outer telescoping lock being connected adjacent to said handle;
said shaft hole being concentrically positioned through said outer telescoping lock and into said handle; and
said insertion end of said first shaft traversing into said shaft hole.

5. The system for an advanced reaching trowel as claimed in claim 4 comprises,
said first shaft being laterally engaged by said outer telescoping lock.

6. The system for an advanced reaching trowel as claimed in claim 1 comprises,
said plurality of trowels comprises a square margin trowel, a large round trowel, and a pointed margin trowel.

7. A system for an advanced reaching trowel comprises,
a plurality of trowels;
a first shaft;
a second shaft;
each of said plurality of trowels comprises a trowel blade and an extension arm;
said first shaft comprises a threaded end and an insertion end;
said second shaft comprises an outer telescopic lock, a handle, and a shaft hole;
said extension arm comprises a blade bracing portion and a threaded port;
said first shaft being sleeved by the second shaft;
said outer telescoping lock being connected adjacent to said handle;
said shaft hole being concentrically positioned through said outer telescoping lock and into said handle; and
said insertion end of said first shaft traversing into said shaft hole.

8. The system for an advanced reaching trowel as claimed in claim 7 comprises,
said blade bracing portion and said threaded port being positioned opposite to each other along said extension arm;
said trowel blade being connected adjacent to said blade bracing portion;
said trowel blade and said threaded port being positioned parallel to each other;
said threaded end and said insertion end being positioned opposite to each other along said first shaft; and
said threaded port being engaged by said threaded end.

9. The system for an advanced reaching trowel as claimed in claim 7 comprises,
said first shaft being laterally engaged by said outer telescoping lock.

10. The system for an advanced reaching trowel as claimed in claim 7 comprises,
said plurality of trowels comprises a square margin trowel, a large round trowel, and a pointed margin trowel.

11. A system for an advanced reaching trowel comprises,
a plurality of trowels;
a first shaft;
a second shaft;
each of said plurality of trowels comprises a trowel blade and an extension arm;
said first shaft comprises a threaded end and an insertion end;
said second shaft comprises an outer telescopic lock, a handle, and a shaft hole;
said extension arm comprises a blade bracing portion and a threaded port;
said first shaft being sleeved by the second shaft;
said blade bracing portion and said threaded port being positioned opposite to each other along said extension arm;
said trowel blade being connected adjacent to said blade bracing portion;
said trowel blade and said threaded port being positioned parallel to each other;
said threaded end and said insertion end being positioned opposite to each other along said first shaft;
said threaded port being engaged by said threaded end;
said outer telescoping lock being connected adjacent to said handle;
said shaft hole being concentrically positioned through said outer telescoping lock and into said handle;
said insertion end of said first shaft traversing into said shaft hole; and
said first shaft being laterally engaged by said outer telescoping lock.

12. The system for an advanced reaching trowel as claimed in claim 11 comprises,
said plurality of trowels comprises a square margin trowel, a large round trowel, and a pointed margin trowel.
